(19) United States
(12) Patent Application Publication
(10) Pub. No.: US 2017/0318978 A1
(43) Pub. Date: Nov. 9, 2017

(54) Smart Rocking Bed Device and System

(71) Applicant: James Flemister, Dallas, TX (US)

(72) Inventor: James Flemister, Dallas, TX (US)

(21) Appl. No.: 15/587,335

(22) Filed: May 4, 2017

Related U.S. Application Data
(60) Provisional application No. 62/391,565, filed on May 4, 2016.

(51) Int. Cl. A47C 21/00; A61H 1/00; A61G 7/057; A61G 7/008; A47C 31/00

(52) U.S. Cl. CPC A47C 21/006; A61H 1/003; A47C 31/008; A61G 7/008; A61H 2201/501; A61G 7/0573

(57) ABSTRACT

A smart powered rocking bed is disclosed comprising a plurality of vertical and horizontal actuators in contact with a rocking frame configured to receive the rocking bed, the electronic actuators configured to act together to rock the bed in three dimensions. The smart powered rocking bed also includes a digital processor configured to electrically drive the actuators in a plurality of predetermined multi-directional and simultaneous ocean-like motions over a period of time provided for a user's choice. The smart powered rocking bed additionally includes a linkage configured to connect the rocking frame to the actuators and mechanically provide the multi-directional and simultaneous ocean-like motions in the three dimensions over time as chosen by the user. A smart powered rocking bed system further includes a health care database, a discrete personal digital device such as a cell phone and health care telemetry sensors placed on or in a user thereof.

### CROSS-REFERENCE TO RELATED APPLICATIONS

This application claims the benefit of the priority date of earlier filed U.S. Provisional Patent Application Ser. No. 62/391,565, filed May 4, 2016 for James Flemister, titled Methods for Achieving Multiple Programmable Desired Motions and Adjustable Positions for Bedding or Furniture Devices, incorporated herein by reference in its entirety.

### BACKGROUND AND FIELD OF INVENTION

Conventional firm and flat mattresses may not be very good at disturbing the body's weight and as a result, pressure hot spots may develop along a sleeper's body. Sleepers may toss and turn from one position to another, mainly to relieve these pressure points, which occur at various places along the body where one comes into contact with a mattress. If these pressure points could be alleviated or removed all together then a sleeper may be able to avoid tossing and turning during sleep and stay sleeping. Many people actually wake themselves from sleep as they reposition themselves to become more comfortable. This, obviously, is not conducive to sound sleep. It is therefore desirable that the body be relieved of the need to frequently change positions without actually having to be physically repositioned.

Some sleep experts have reported that the average person tosses and turns 40-60 times during the night. According to multiple scientific sleep studies, more than 70 million Americans may suffer from sleep disorders, such as acid reflux, inflammation, insomnia, sleep apnea, general stress related issues, toxicity, and other health related problems. Sleepers with these conditions experience difficulty initiating or maintaining sleep, often resulting in impaired daytime functioning. In one poll, 35 percent of all adults experienced sleep disorder symptoms every night, with 58 percent reporting insomnia at least a few nights per week. Additionally, more than 100 million Americans are, by definition, chronically sleep-deprived.

It is known that the rocking of a baby cradle helps a child to sleep and may have even given rise to the saying, ‘sleep like a baby.’ For an adult, a cruise ship may give an unusual and profound sleep experience and help one fall into a much deeper and more complete sleep than a passenger has experienced before. And after a couple of days on a cruise ship, a passenger may feel more youthful and walk with a “bounce” in their step. There may be several factors at play that allow a better sleep on a cruise ship. One factor may be the roll of the ship in response to ocean waves sufficient to generate movement of a passenger's bed (Beds placed head to foot in a bow to stern direction may not be affected by the ship's motion).

Some studies have shown that rocking increases blood and lymphatic circulation. The heart may pump blood and nutrients into the cells, but to carry toxins away from the cells, the body requires motion. This may be because the body's drainage system, the lymphatic system, has no pump. Doctors know that people without enough movement, or who are bed-ridden, may quickly develop serious health problems. For example after surgery, patients may be asked to get up and move around as soon as possible, even if exhausted and totally in pain. Rocking may therefore speed postoperative recovery and reduce pain.

Additionally, patients may find that rocking just feels good! By reducing backpressure in the circulatory system, rocking motion may decrease swelling throughout the body. Muscles and tissues may stretch and relax during rocking. Soreness, aches, pain and swelling may also diminish noticeably right away through rocking. Rocking may be therefore much more relaxing and more therapeutic than simply lying down. Rocking may create a pumping action that increases circulation between the spinal discs and other joints, bathing a sleeper's cells in fresh nutrients. The nervous system may recognize this and send signals of pleasure to encourage the sleeper or rocker to continue.

Other benefits of rocking are being discovered and acknowledged at the frontiers of science. For example, rocking may increase oxygen delivery to the cells. The body burns calories via oxygen to generate electricity to power muscles and the nervous system. Reduced oxygen to the cells may therefore result in chronic pain, suffering and disease. Cells are starved for oxygen until the lymphatic vessels remove toxins, blood proteins, and water. Rocking promotes this electrochemistry, effectively turning on the “switch” to increasing overall health, energy, and alertness.

Traditionally, most sleep research has centered on the use of drugs or medicine to solve various sleep disorders. There is now sound evidence of the positive affect of rocking. Current sleep studies, as a whole, seem to be missing the link between the gentle, soothing rocking motion on the body's gravitational and lymphatic system and its connection thereto. Current research is discovering how important rocking is for psychosocial well-being; its use has spread far beyond the mother/child cradle, and can be a cure for a wide range of health problems. Further studies have shown that the gentle motion of rocking may release endorphins, a chemical known to improve mood and lessen pain. The studies also indicate that rocking therapy may increase the quality of life for people suffering from Dementia and Alzheimer's disease.

Other studies have indicated the calming movement of rocking can dramatically speed up the healing process in severely ill patients. In addition, rocking may be used as therapy for post-surgery recovery. Cases have been reported of patients recuperating from heart attack and stroke—without any trace of permanent damage—simply because they used rocking therapy while they were recovering. People bedridden with arthritis may be up and around inside a week after regular use of rocking therapy. Rocking therapy may be applied to the following health issues, with remarkable results:
Dementia
Alzheimer's
Autism
Chronic Fatigue Syndrome
Stuttering
Diabetes
Arthritis
Heart Disease
Surgical Recovery
Mental Illness

While a body is being rocked in a traditional rocking chair, the body is mostly upright in a sitting position. A body, while in a lying position, on the surface of a mattress being rocked may have similar forces acting upon it. A rocking bed may therefore have extremely positive uses in any and all rocking situations whereby one may be benefited by its rocking motion.

However, much of the bedding industry has sought to solve the problem of a body's weight bearing down on a flat, non-moving bed surface by either softening or contouring mattress surfaces. There are hundreds of inventive ideas in the prior art dealing with the improvement of the sleep surface but none have been found that seek to move the mattress in ways that preclude a sleeper from having to reposition themselves during sleep and offer therapeutic benefits at the same time.

### SUMMARY OF THE INVENTION

A smart powered rocking bed is disclosed comprising a plurality of vertical and horizontal actuators in contact with a rocking frame configured to receive the rocking bed, the electronic actuators configured to act together to rock the bed in three or more dimensions. The smart powered rocking bed also includes a digital processor configured to electrically drive the actuators in a plurality of predetermined multi-directional and simultaneous ocean-like periodic motions over a period of time provided for a user's choice. The smart powered rocking bed additionally includes a linkage configured to connect the rocking frame to the actuators and mechanically provide the multi-directional and simultaneous ocean-like motions in the three dimensions over time as chosen by the user.

A smart powered rocking bed system further includes a health care database, a discrete personal digital device such as a cell phone and health care telemetry sensors placed on or subcutaneously in a user thereof. A non-transitory processor-readable storage medium is also disclosed having one or more instructions which when executed by at least one processing circuit causes the at least one processing circuit to perform the steps below.

A smart powered rocking bed method and computer program disclosed comprise components of providing a plurality of vertical and horizontal actuators in contact with a rocking frame configured to receive the rocking bed, the electronic actuators configured to act together to rock the bed in three or more dimensions. The method and computer program also include components of a digital processor configured to electrically drive the actuators in a plurality of predetermined multi-directional and simultaneous ocean-like motions over a period of time provided for a user's choice. The method and computer program additionally include components of a linkage configured to connect the rocking frame to the actuators and mechanically provide the multi-directional and simultaneous ocean-like periodic motions in the three dimensions over time as chosen by the user.

The disclosed method and computer program further include components of providing a user of the bed with a menu of motions and a database of health care sensory data collected via telemetry from the user to enable a choice from the user regarding the motions over a period of time also chosen by the user.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 is a top view depiction of a smart powered rocking bed device and system including a frame, a drive train and linear actuators in accordance with an embodiment of the present disclosure.

FIG. 2 is a side view depiction of the upper base frame mechanism of the smart powered rocking bed device and system including the frame, drive train and linear actuators in accordance with an embodiment of the present disclosure.

FIG. 3 is a head end depiction of the lower base frame mechanism of the smart powered rocking bed device and system including the frame, drive train and linear actuators in accordance with an embodiment of the present disclosure.

FIG. 4 is a side view depiction of the top base platform of the smart powered rocking bed device and system including the frame, drive train and linear actuators in accordance with an embodiment of the present disclosure.

FIG. 5 is a side view depiction of an adjustable bed resting atop the top base platform attached to the upper rocking base frame of the smart powered rocking bed device and system in accordance with an embodiment of the present disclosure.

FIG. 6 is a depiction of a U-shaped pivot coupling bracket of the smart powered rocking bed device including an inside bracket and a center pivot bolt in accordance with an embodiment of the present disclosure.

FIG. 7 is an end view depiction of the U-shaped pivot coupling bracket of the smart powered rocking bed device including an inside bracket and a center pivot bolt in accordance with an embodiment of the present disclosure.

FIG. 8 is a flow chart of a method for in accordance with an embodiment of the present disclosure.

FIG. 9 is a block diagram of the device and system for the smart powered rocking bed device in accordance with an embodiment of the present disclosure.

Throughout the description, same and similar reference numbers may be used to identify same and similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘sleeper’ may refer to a person, pet, animal and any other living thing in a sleeping state. The term ‘bed’ may refer throughout to at least one of a mattress, a box spring or mattress support and to both the mattress and the support as a bedding unit. Also the terms fore and aft are used synonymously with the respective terms head and foot in the present disclosure. The term ‘actuator’ refers to a component of the smart bed device and system that is responsible for moving or controlling the smart bed device and system and converts energy (power from air, electricity, chemical, mechanical or liquid) to create motion in a straight line; contrasted with circular motion of a conventional electric motor. The control signal is relatively low energy and may be electric voltage or current, pneumatic or hydraulic pressure, or even human power. The term ‘smart’ refers to digital and programmable content including non-transient program code and respective circuits configured to implement the program code via an embedded processor, a discrete processor, a laptop, a desktop computer, a smart phone, a tablet and any other digital processor device for personal and shared use.

Methods and motions are disclosed for moving at least one surface of various beds or furniture devices via programmable motion-inducing mechanisms situated below an item to be rocked and at other positions for other desired motions. The item to be rocked includes a bed, an adjustable bed, a crib, an item of furniture, a vehicle seat and any other suitable attachment mechanism that would provide adequate structural integrity to the upper rocking frame while also acting as a noise suppressor and cushioning device at the same time. A means of securing at least one motor or drive mechanisms; a physical means of imparting motion from a motor or drive mechanism to an aspect of a frame or support structure of an item to be rocked; said drive mechanism(s) capable of imparting multi-directional and simultaneous motions that may mimic ocean-like motion acting upon a floating or sea going ship or vessel at sea such as a catamaran, cruise ship or other object; said motion(s) types being induced to said one or more surfaces of said item.

The present application discloses novel methods of inducing various single and simultaneous multiple motions to one or more surfaces of beds and furniture devices via mechanical or electronic programmable motion-inducing mechanisms situated there below. The beds and furniture items further include adjustable beds, cribs, and furniture for resting or sleeping and vehicle seats. The said mechanisms are enabled to also mimic sea waves-induced sensations experienced upon a floating object.

These motions are controlled mechanically or electronically via a programmable system, wherein said motions consist of one or more of the following with variable degrees of each: a gentle or more aggressive or stuttered head to foot rocking motion, side to side, yawing, up or down vertical motions either singularly acting upon the device to be rocked or in combined motions. These motions could be delivered to the object to be rocked to a single surface or multiple surfaces with independent control of motions to each surface.

The subject mechanism is wire controlled or remote controlled by the user or remote software via a pre-set software program or otherwise that controls all speed ranges, directions and ranges of travel. Said mechanism consists of a single or multiple pivot points located below the object or objects to be rocked and positioned in the approximate middle or laterally positioned in the approximate center of said rocking mechanism or elsewhere at or near the various corners of said mechanism. An embodiment includes movable pivot points either manually or automatically.

The mechanism encompasses a manual or automatic “kill switch” in case of any unexpected incident or sensor reading that may indicate an unsafe condition and be designed to return to a level, horizontal, or pre-determined position when in the “off” position for convenience and safety.

The invention also encompasses a method of modifying one or more said motions as a function of inputs from biological sensors used by a user or as a function of data there from. Motion types are correlated to sleep states and used to optimize motion types by the user for desired sleep state inducements or continuity. A database and analytic engine are designed to store user motion and adjustable bed position type over time periods and subjective or objective measures of satisfaction or sleep quality. Said association of motions and positions are offered as menu options to users who wish to experience selected benefits or have health conditions such as breathing difficulty, snoring, apnea, heart failure, joint pains, wounds, which are associated with benefits from data and findings of said database and analytic engine or with personal experience of said Invention.

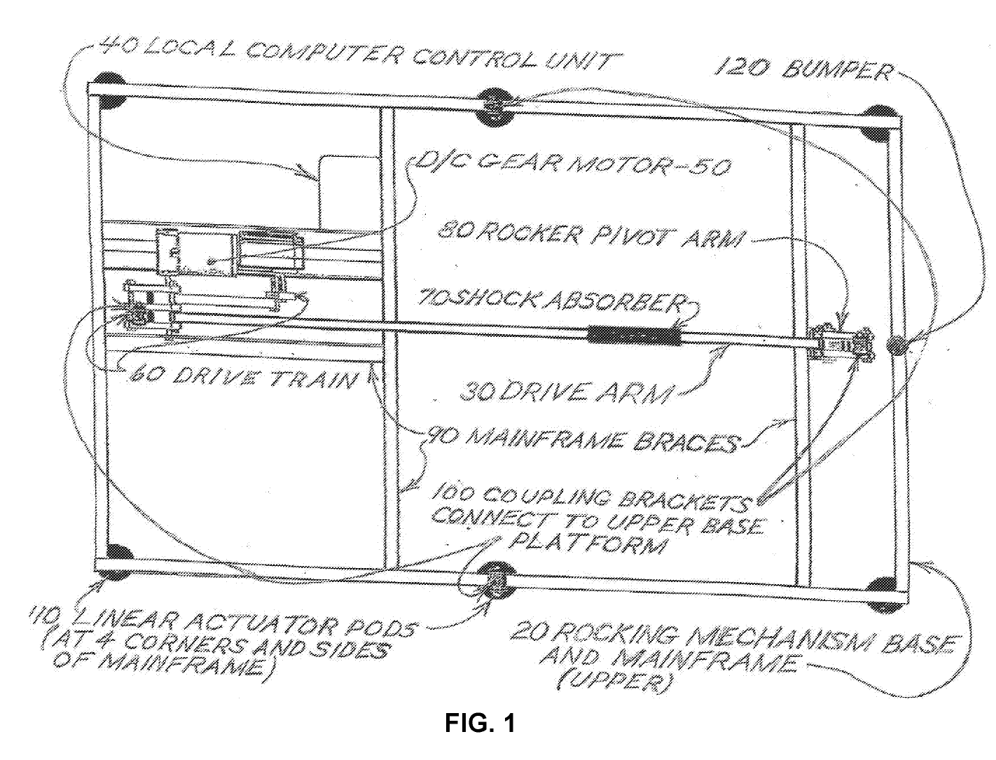

FIGS. 1, 2, and 3 depict the lower rocking base frame mechanism attached to, below, and supporting the upper rocking frame mechanism. Together they are designed to impart various and sundry desirable motions to objects to be rocked mimicking the actual sensations and motions of sea waves upon a ship or vessel at sea as described in this summary

The embodiments herein also anticipate other mechanisms of inducing rocking motion such as one or more members of the group: rotary motor, D.C gear motor, A.C. motor, drive arm, a piston, a cam, a flywheel, a slip clutch, a rocking pivot arm, a linear actuator, hydraulic, piezoelectric, electromagnetic, pulley and cable positioned at various points on a lower base and upper rocking mechanism frame to produce motion to a top base platform positioned atop the rocking mechanisms working in tandem together. The purpose of said motion is to produce desirable motions to the items to be rocked that are located atop said mechanisms.

In a further embodiment, not shown, is a method of said mechanism to allow for and to enable said motions to be imparted by said device to one or more objects to be rocked either together in sync with one another, in separate controlled motions or independently from one another. The exemplary though not exhaustive Figures herein describe a few possible and envisioned embodiments of rocking methods to flat beds, adjustable beds, cribs, furniture or vehicle seats. The directions, degrees of travel, or speed of rocking motion is not limited by the embodiments shown and may include pitch, roll, yaw, up and down vertical movements in degrees of time and may include multi-directional simultaneous movement.

FIG. 1 is a top view depiction of a smart powered rocking bed device and system including a frame, a drive train and linear actuators in accordance with an embodiment of the present disclosure. The embodiment consists of two separate and distinct mechanisms linked together one atop the other. The lower mechanism 130 known as the lower base frame rocking mechanism is supporting the upper mechanism frame 20 described as the upper rocking base mechanism. Various components of said mechanisms are explained in detail via the following description.

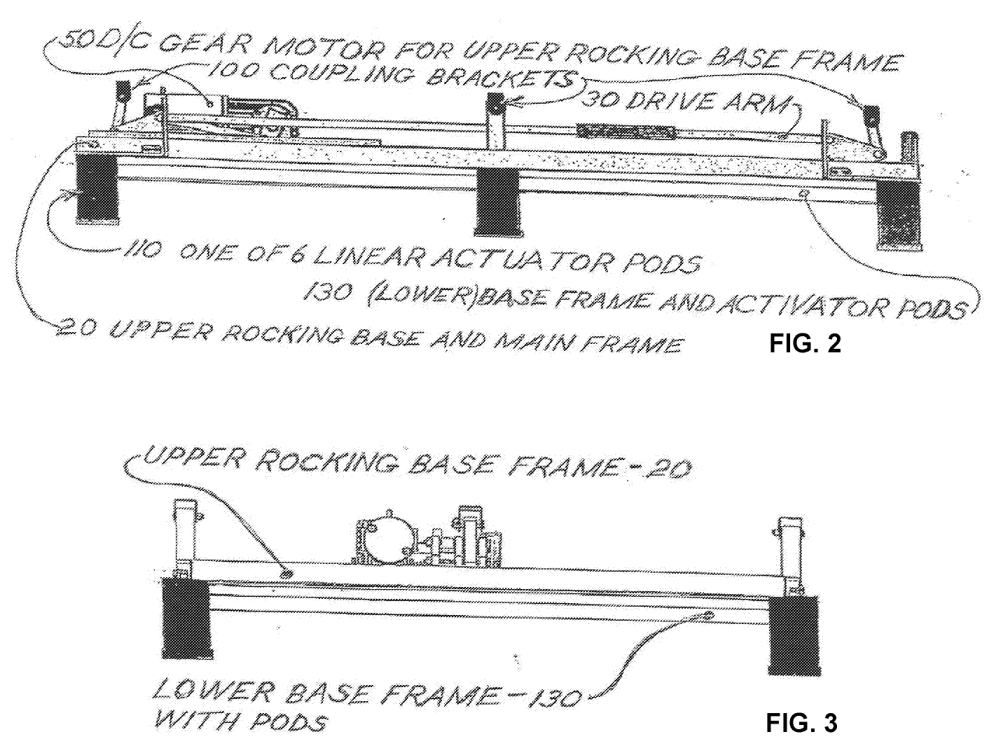

FIG. 2 is a side view depiction of the upper base frame mechanism of the smart powered rocking bed device and system including the frame, drive train and linear actuators in accordance with an embodiment of the present disclosure. The mechanism includes the frame 20, main frame braces 90 and ancillary components consisting of a D/C gear motor 50, a drive assembly composed of drive train 60, drive arm or push rod 30, shock absorber 70 and rocker pivot arm 80 and other devices, modes and methods of generating desired motions. A purpose and function of the mechanisms is providing a separate and distinct component that is attached to a lower base frame 130 and capable of delivering a head to foot rocking motion to objects to be rocked atop the device and upon top base platform 140. The mechanism is connected to the lower rocking base frame at four or more coupling brackets 100 mounted at strategic points on upper rocking base mechanism 20. The device would encompass one or more pivot points located in the approximate middle and laterally positioned on the sides of the frame. The device may position one or more safety bumpers 120 at or near the foot end of upper rocking base frame mechanism 20 to help relieve sudden or unusual and exceptionally heavy loads placed upon or about the foot end of the mechanism. The safety bumpers 120 work in conjunction with safety shock absorber 70 in the midst of drive arm 30, whereby pressure is relived on the entire drive mechanism; thus providing a level of functional safety to the mechanism and ancillary component parts.

In another embodiment, the lower base frame 130 located below the upper rocking base mechanism 20 is equipped with one or more linear actuator pods 110 or other motion generating devices required to bring about various and sundry motions acting upon the underside of said upper rocking base frame mechanism 20. The disclosed motions direct the upper base frame mechanism to produce a desired one or more motion types per unit of time including to randomly change the amplitude of a wave type motion and to vary the stroke length. The vertical up and down motion of the device mimics a smooth sea or a more choppy sea or wave like action to the items or surfaces of items to be rocked individually or corporately. The lower base frame 130 and upper base frame 20 are operated or controlled mechanically or electronically via a user, computer software program or control unit 40, remote controlled, or remotely monitored or by a pre-determined, programmable software program.

FIG. 3 is a head end depiction of the lower base frame mechanism of the smart powered rocking bed device and system including the frame, drive train and linear actuators in accordance with an embodiment of the present disclosure. The depiction includes the lower base frame with vertical actuator pods 130 showing upper rocking base frame device 20 atop and attached at various pod locations 110 to lower base frame 130. Also shown is head end view of D/C gear motor 50 and partial view of drive train 60.

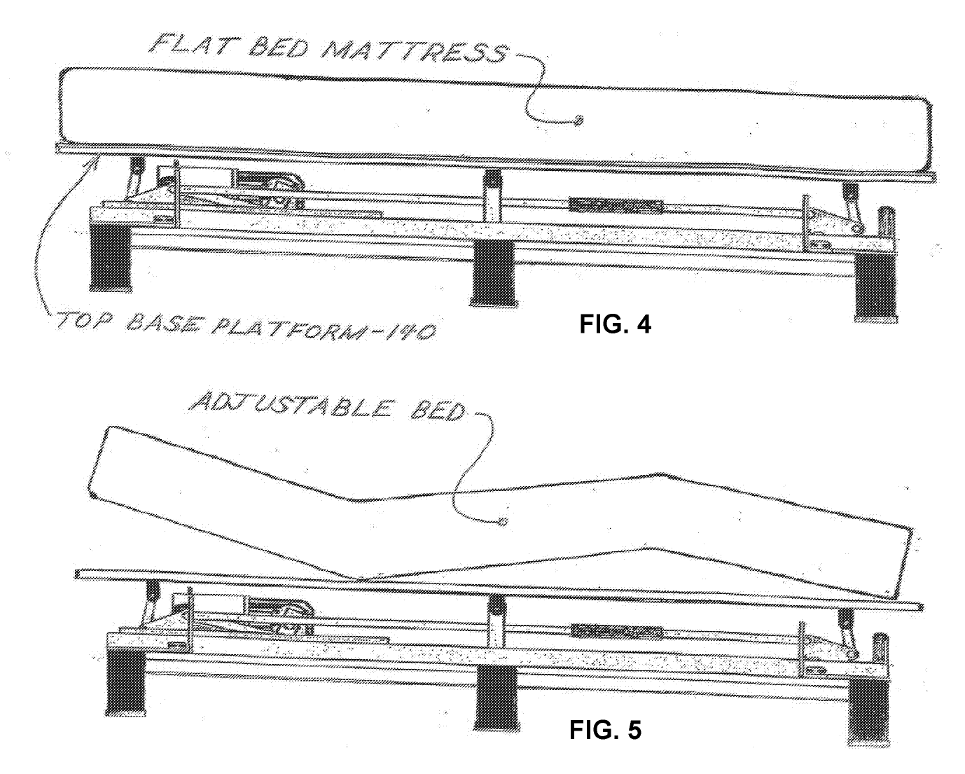

FIG. 4 is a side view depiction of the top base platform of the smart powered rocking bed device and system including the frame, drive train and linear actuators in accordance with an embodiment of the present disclosure. The depiction includes a “flat bed” mattress resting atop the top base platform 140 while the platform is firmly attached to the upper rocking base frame via coupling brackets 100, for delivering the desired motion to the user.

FIG. 5 is a side view depiction of an adjustable bed resting atop the top base platform attached to the upper frocking base frame of the smart powered rocking bed device and system in accordance with an embodiment of the present disclosure. The depiction includes an adjustable bed resting atop the top base platform 140 while the platform is firmly attached to the upper rocking base frame via coupling brackets 100, thus delivering the desired motion to the user. Note the tops and bottoms of the two parts are firmly attached to the upper rocking base mechanism top base platform or base of the item to be rocked there above.

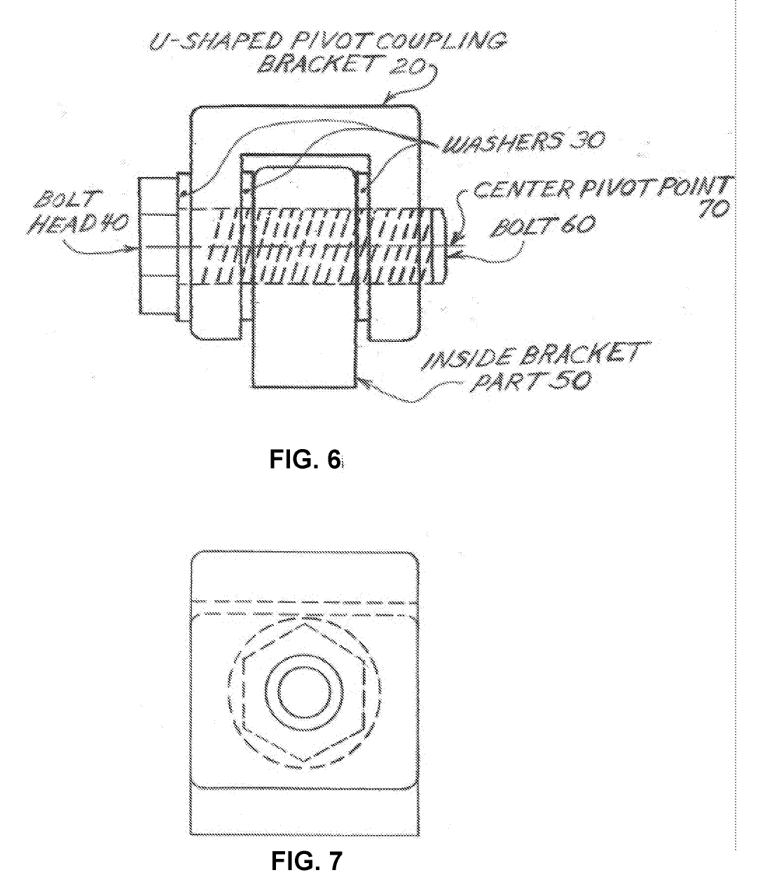

FIG. 6 is a depiction of a U-shaped pivot coupling bracket of the smart powered rocking bed device including an inside bracket and a center pivot bolt in accordance with an embodiment of the present disclosure. This bracket consists of two separate “U” shaped stainless steel or galvanized metal brackets affixed together by way of a single shoulder bolt and washers made from a plastic, ceramic, rubber or any other material to cause any pivoting motion produced to be very silent when in motion. There could be many other methods of attachment implemented however, such as a swing arm of some type, rubber attachment devices that could provide a swivel type effect and so on. Cushioning plastic washers 30 are used for the purpose of suppressing noise and extending the life of the coupling mechanism. Notice bolt 40 and 60 lock the two parts of the coupling 20 and 50 together and, thus provide a coupling for a rocking mechanism to an item or platform attached above. The bracket part 50 is the second part of said pivot coupling bracket that completes the connection of any two items being attached. Both brackets as attached to their respective items can be welded at their points of contact with their counterparts, bolted on or affixed in any other method so as to complete the connection of said items in a safe and stable manner.

FIG. 7 is an end view depiction of the U-shaped pivot coupling bracket of the smart powered rocking bed device including an inside bracket and a center pivot bolt in accordance with an embodiment of the present disclosure. The tops and bottoms of the two parts linked together are firmly attached to the rocking mechanism upper platform and to frame or base of the item to be rocked above.

In other words, at least one mechanism is enabled to impart one or more motion types wherein said motion is a member of pitch, yaw, roll, up and down vertical motion, speed, degree of travel in a direction; to an item which is a member of the group: a bed, an adjustable bed, a crib, furniture, vehicle seat; wherein said motion enablement is at least one of a single motion per unit of time, multiple motion types and degrees per unit of time. The at least one mechanism is enabled to impart said motion(s) independently and differentially to more than one surface of a device.

In a further embodiment, the mechanism(s) is/are a member of the group rotary or D.C gear motor, A.C. motor, a slip clutch, drive arm, a piston, a cam, a flywheel, roller bearings a rocking pivot arm, a linear actuator, hydraulic, piezoelectric, electromagnetic, pulley and cable. The device assumes a user-selected position when switched off and an automatic safety kill switch with associated trigger parameters.

An embodied method is pre-determined and programmable. The method directs the mechanisms claimed and described herein to produce a desired one or more motion types per unit of time including a random change in the amplitude of a wave type motion. The embodied method also varies the stroke length and the vertical up and down motion of the device to mimic a smooth or a more choppy sea or other wave like action. Embodied methods are also disclosed wherein the mechanism(s) are at least one of controlled by a local computer or control unit, remote controlled, controlled by a user or remotely monitored.

At least one of a single and multiple pivot points are located below the objects to be moved and include at least one stationary pivot point positioned in the approximate middle or lateral center of the rocking mechanism and the moveable one or more pivot points. Independently addressable surfaces of the disclosed bed enable each sleeper to have a different motion or none induced to their sleep surface.

The disclosed embodiments and motions as a function of inputs from biological sensors are available to a user and data obtained is stored pertaining to motion types experienced by the user and the effect on the user. The data is associated with a user and the user's sleep and health attributes. The data is used to produce desired motions upon command. Motion types may be correlated to sleep states and used to optimize the user's desired sleep state induced or continuity of sleep. Positions of an adjustable bed as well as motion types thereof are incorporated in the above process to combine both motion and adjustable bed positions for a user to achieve a desired state. Data is obtained from an implantable device in a user and used to modify an aspect of motion or adjustment to an adjustable bed position.

An application for the disclosure includes a smart user device such as a phone, which connects with data pertaining to attributes of both bed motion and adjustment positions over periods of time. The application includes enabling the user to assign one or more scores with respect to sleep and other personal satisfaction attributes linked to the bed motion and positions. Data from the application is used to dynamically adjust motion types and bed positions to best suit a user at any determined period of time.

An embodiment includes a database and analytic engine configured for obtaining, storing and analyzing the data from explained above for one or more users as well as a user's health status, physiological attributes and maladies. A menu of pre-programmed motions and or adjustable bed positions over definable time periods are associated with a user's physiological requirements or preferences. The pre-programming is a function of user-described benefits and preferences and user physiological health profiles.

Sensors for biological parameters of a users' physiological attributes may be worn or incorporated into the device and system or mattress or otherwise be in contact with the user and a network connecting the foregoing. The network is further capable of remote monitoring of data from the above parameters. The network thus disclosed is enabled to integrate and communicate with user smart devices such as computers and smart phones and other personal digital devices.

Thus, any person lying on a mattress that is resting upon the upper surface of this rocking box spring device will succumb to the gentle and soothing head and foot rocking, rolling or see-saw motion that is exerted upon said mattress. A sleeper using the disclosure, may have a strong tendency to relax, and shortly, to fall into a very deep and serene sleep state. This action claimed by the disclosure is designed to deliver a soothing, gentle and relaxing sensation to the body laying or sitting on the mattress surface above the rocking box spring bed device. Thus, providing a drug free, best way to reduce stress and prepare the sleeper to fall asleep quickly and deeply.

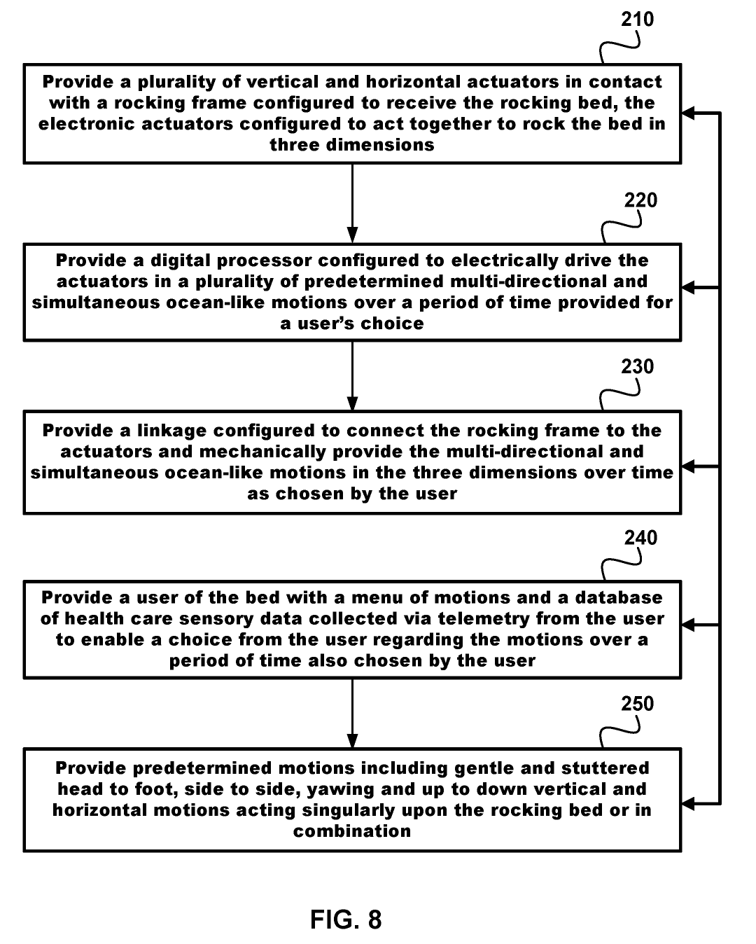

FIG. 8 is a flow chart of a method for in accordance with an embodiment of the present disclosure. The smart powered rocking bed method and computer program disclosed comprise components of providing 210 a plurality of vertical and horizontal actuators in contact with a rocking frame configured to receive the rocking bed, the electronic actuators configured to act together to rock the bed in three dimensions. The method and computer program also include components of providing 220 a digital processor configured to electrically drive the actuators in a plurality of predetermined multi-directional and simultaneous ocean-like motions over a period of time provided for a user's choice. The method and computer program additionally include components of providing 230 a linkage configured to connect the rocking frame to the actuators and mechanically provide the multi-directional and simultaneous ocean-like motions in the three dimensions over time as chosen by the user.

Embodiments of the disclosed method and computer program further include components of providing 240 a user of the bed with a menu of motions and a database of health care sensory data collected via telemetry from the user to enable a choice from the user regarding the motions over a period of time also chosen by the user. The embodiments also include components of providing 250 predetermined motions including gentle and stuttered head to foot, side to side, yawing and up to down vertical and horizontal motions acting singularly upon the smart powered rocking bed or in combination therewith.

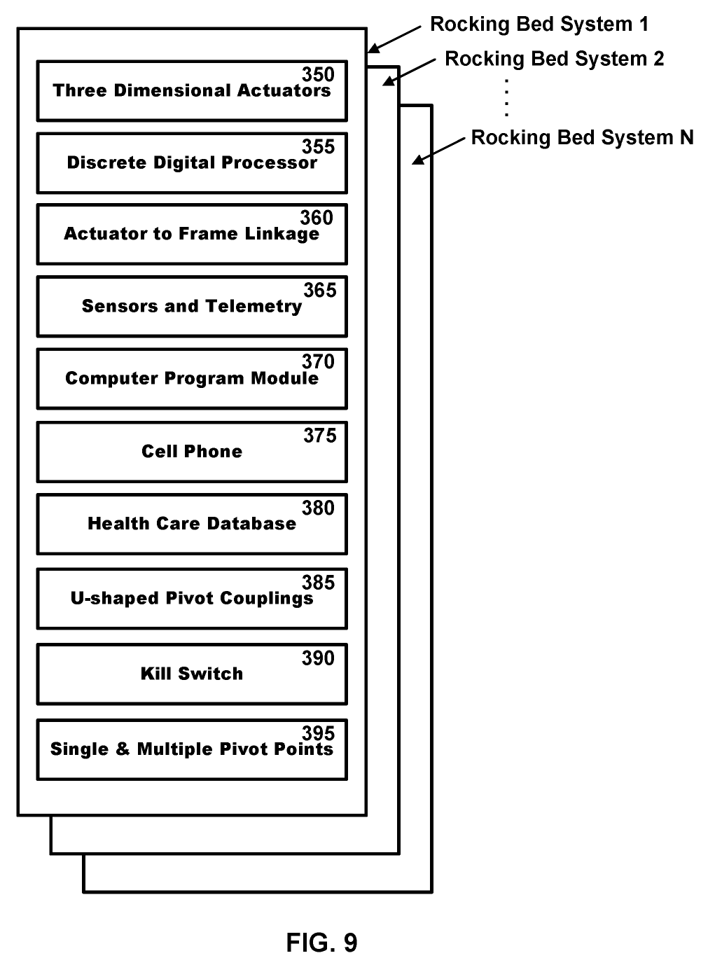

FIG. 9 is a block diagram of the device and system for the smart powered rocking bed device in accordance with an embodiment of the present disclosure. The device and system include three dimensional actuators 350, a discrete digital and/or signal processor 355, an actuator to frame linkage 360, sensors and telemetry components 365, a computer program module 370, a cell phone and/or any other personal digital device 375, a health care database 380, a U-shaped pivot coupling 385, a kill switch 390 and single and multiple pivot points 395. The disclosure also includes components for simultaneous and serial multiple smart rocking beds 1, 2 up to N in number.

In an embodiment of the disclosure, motion types may be correlated to sleep states and used to optimize motion types chosen by a user for desired sleep state inducements or continuity of sleep. Sleep states include REM (rapid eye movement sleep), non-REM light sleep, deep sleep and even napping. Positions of an adjustable bed as well as motion types may be incorporated in the above process to combine both motion and adjustable bed positions for a user to achieve a desired sleep state. Data may be obtained from a device within a user and used to modify an aspect of motion or adjustment to adjustable bed position. Users may swallow the device, have it implanted subcutaneously or held in or on the body of the user.

Also in an embodiment, a load balancing and support frame is operatively connected to an attachment point as a means of attaching the motion imparting mechanism to an item support frame comprising a load-bearing bar or structure configured to reduce load stress on moving joints and assemblies at points of contact.

This entire system or structure can be totally self-contained in a flatbed structure of its own or an adjustable bed structure or piece of furniture in and of its self. These systems, mechanisms or devices would be totally self-contained in one structure and covered with any number of suitable materials for aesthetic appeal and safety purposes. It is intended this self-contained structure configuration could also be used in a child's bed, a baby crib, an animal bed, indoor and outdoor furniture or any other number of applications where a smooth, relaxing and gentle rocking motion in the head to foot direction and in the manner described in this application is desired. Embodiments of the disclosure include the drive mechanism and other moving parts may be soundproofed and insulated to ensure a sound sleeping experience for the sleeper.

Methods are disclosed for attaching a rocking mechanism situated below an item to be rocked, the item being a member of the group: a bed, an adjustable bed, a crib, an item of furniture, a vehicle seat. A means of securing a motor; a physical means of imparting motion from a motor to an aspect of a frame or support structure of an item to be rocked; an attachment means of the imparting mechanism to a frame or support structure; and a load stabilization means are disclosed.

A method of coupling a rocking mechanism situated beneath an item to be rocked, wherein the item to be rocked is a member of the group: a bed, a rocking bed, a crib, an item of furniture; said method comprising a rocking mechanism affixed to a support base, a mechanism enabled to impart motion from a motor to at least one point of a supporting structure of the item to be rocked, a means of connecting the said mechanism to the said at least on point of the item supporting structure; wherein the item supporting structure rests upon one or more pivot points.

A method is disclosed wherein the mechanism enabled to impart motion is a member of a drive arm, a piston, a cam, a flywheel, a rocking pivot arm. A method of securing a mechanism enabled to impart motion to at least one point of a supporting structure that is a member of a u-shaped pivot, a u-shaped bracket, a rubber coupler, a bolt, a bolt with bushings.

A method is disclosed wherein a coupling structure connecting a lower frame to a support structure of an item is adjustable in at least one dimension and is enabled to pivot and wherein the end points of said support structure affix to at least one point of a frame or a support point of an item to be rocked.

A mechanism is disclosed wherein one of a bumper, a damper, a shock absorber is affixed to a motion transmission mechanism. A motion imparting mechanism connected to a motor and to an item frame or support point comprising: a drive arm, a cam, a piston, a spring, a flywheel, a rocking pivot arm. This invention describes a unique and non-obvious method of coupling or attaching an item: a flat bed, an adjustable bed, crib, a dogs bed, a piece of furniture or any other item to an inventive rocking base that acts on any upper item positioned atop the rocking mechanism upper frame positioned below. The rocking mechanism operates in such a way as to produce a gentle, rhythmic, and relaxing sensation upon a body(ies) lying on the platform above, thus, promoting a rapid, deep, and rejuvenating sleep state. Using coupling methods as configured and shown are ideal in light of functionality, load support and safety. The primary method of coupling said items to one another is strategically designed to facilitate a gentle rocking motion to the item attached above while providing a sturdy coupling device that pivots about a point in the coupling method.

A “U” shaped pivot attachment bracket may be employed to attach the two separate items together. This bracket may consist of two separate “U” shaped stainless steel or galvanized metal brackets affixed together by way of a single shoulder bolt and washers made from a plastic, ceramic, rubber or any other material to cause any pivoting motion produced to be very silent when in motion. There could be many other methods of attachment implemented however, such as a swing arm of some type, rubber attachment devices that could provide a swivel type effect and so on.

We show the end brackets as rocking coupling support brackets. In said figures we show the side brackets as center pivot brackets. Attachment brackets to furniture or any other items could use similar coupling devices as described in this summary. The embodiments herein also anticipate other mechanisms of inducing rocking motion such as pistons or cams or drive arms positioned at various points on a lower frame and enabled to induce motion to an upper frame. Coupling methods for such mechanisms to the items to be rocked and their frames or support points may be deduced from the teachings of the Invention. For example, a piston, flywheel or cam may induce motion to the frame or support points of an item to be rocked by either direct contact or device connecting both the motion-inducing device and the said frame or support structure. In a further embodiment, not shown, a coupling device may be a comprised of extensible and pivot-enabled arms connecting a lower frame to the frame or support points of the item to be rocked wherein the extensible and pivot-enabled arms can slide to various lengths and pivot to various points so as to connect with and support various points of an item's frame or support points.

The exemplary though not exhaustive Figures herein describe a few possible and envisioned embodiments of coupling methods to beds, adjustable beds and cribs. The direction of rocking is not limited by the embodiments shown and may include side-to-side and multi-directional simultaneous movement.

Those with ordinary skill in the art of the design of bed foundations and mechanical drives systems will appreciate the following drawings as enabling. The aspects of the invention that include innovations and improvements over known devices in terms of materials, mounting, driving, and fabrication are described in the following figures. We show the rocking bed base frame with no feet attached at or about the four corners of the base frame. We show the drive mechanism of the preferred embodiment may consist of a D.C. gear motor, flywheel or cam type device, that actuate rocking pivot arms that in turn move a singular or multiple drive arms, that when moving, actuate the end rocking coupling support brackets.

Center pivot brackets function as support for the rocking of an attached upper base frame that could be a base for a standard flat bed, adjustable bed, crib, or other furniture and allow the upper frame to pivot upon these points at a distance approximately mid-way between the longitudinal ends of the base frame and are located on the sides or the base frame. The four locations of the coupling attachment brackets are designed to provide structural integrity and a means of coupling to and supporting an item to be rocked located directly above the rocking mechanism. Additionally, these center pivot coupling brackets allow for the upper located item to be gently rocked in a head to foot direction while at the same time provide mid-range support for the overhead item. The end rocking coupling support brackets drive the head to foot rocking motion while the rocking mechanism is in motion. The “U” shaped coupling brackets are made from standard stainless steel, galvanized steel brackets or any other durable substance in various sundry shapes and sizes either welded, bolted or affixed securely in any way to the above item or structure to be rocked.

A rocking mechanism is disclosed below a standard flatbed positioned atop the rocker and the two items are firmly attached at the sides and ends of the structure using the various coupling means. The rocking mechanism with feet is fastened to the base at four corners of the frame. Additionally, we show a necessary support leg at approximately mid-center of the longitudinal side beams of the rocking base frame and reaching downward to the floor. This method provides additional support to the overall mechanism at such times that the four corner legs are attached. We show a type of shock absorber placed somewhat in line with the drive arm, thus allowing the drive arm to expand or extend when excess weight is bearing down on the foot end or side ends of the rocking mechanism frame.

This then allows for the rocking pivot arm at the foot end of the mechanism to dip downward to a point where the upper item base end, when atop the rocking base, makes contact with bumper and stops the downward momentum until downward pressure is relieved from the foot end or side ends of the rocking mechanism. This effect would apply to the opposite end of the structure if in the unlikely event excessive pressure was to bear down on the head end of the structure. A similar bumper would need to be located at the head end to facilitate this ability if desired.

A disclosed rocking mechanism rest on the floor or other similar flat surface with a crib securely fastened to the six support coupling brackets. The brackets could be attached directly to the crib base or a support base could be provided already mounted upon the rocking mechanism upper platform and then have other mounting procedures that involve attaching devices such as glues, Velcro or many other types of fastening materials. It is intended this method of coupling or attaching a rocking mechanism to items to be rocked such as an adult flat bed, adjustable bed, child's bed, a baby crib, an animal bed, indoor and outdoor furniture or any other number of applications where a smooth, relaxing and gentle rocking motion in the head to foot direction and in the manner described in this application is unique to these types of applications and provides a high level of suitability and safety to the overall mechanism and any and all humans or animals that are exposed to it in its various modes and applications.

A typical U-shaped pivot coupling Bracket with cushioning plastic washers is used for the purpose of suppressing noise and extending the life of the coupling mechanism. Notice bolts to lock the two parts of the coupling together and, thus providing a coupling for a rocking mechanism to an item or platform attached above. The bracket part is the second part of said pivot coupling bracket that completes the connection of any two items being attached. Both brackets as attached to their respective items can be welded at their points of contact with their counterparts, bolted on or affixed in any other method so as to complete the connection of said items in a safe and stable manner.

Again, the tops and bottoms of the two parts linked together need to be firmly attached to the rocking mechanism upper platform and the frame or base of the item to be rocked above.

In another embodiment (not depicted), the disclosed rocking box spring depicts the rocking box spring in the head and foot horizontal position where the head and foot are both in the horizontal position. A rectangular lower base frame is the basis of support for a D.C. gear motor or any other drive mechanism, rather hydraulic, pneumatic, water powered or otherwise and a skeletal structure supports the drive train mechanism. The drive train mechanism consists of a D.C. gear motor, a flywheel, a push rod, a rocker suspension arm, a mid-base frame support, an upper base frame and a foam mattress rest support. The gear motor slowly drives the flywheel that is connected by a horizontal armature protruding from the D.C. gear motor.

As a push/pull rocking motion is exerted upon the suspension rocker arm via the push rod, the exact motion is exerted upon the mid-base frame support, as it is firmly affixed to both the suspension rocker arms located on both transverse and opposite sides of skeletal structure support at the swivel connects. Thus, a push/pull, smooth and gentle, “cam” and “arc inertia” motion, in the head and foot direction, is applied to the mid-base frame support and to the foam mattress rest support. The purpose of foam mattress rest support is to invoke a random or a pre-determined, controlled, unique and novel, “arc inertia” and “cam” like motion, in the head and foot longitudinal direction, such that it effects a cyclic rolling and rocking (see-saw) motion that would be transferred to a mattress placed upon the foam mattress rest support. Finally, the entire disclosed bed device may be covered with a type of stretching or expandable material to provide a security feature, an aesthetic appearance to the overall device, as well as, having a sound proofing affect. Thus, action is designed to deliver a controlled, soothing, gentle and relaxing sensation to the body laying or sitting on any type of mattress resting atop the mattress rest support and creating the best, most easily achieved, drug free way known to this inventor to reduce stress and prepare the sleeper to fall asleep quickly and deeply.

Furthermore, in a disclosed embodiment (not depicted), when the rocking box spring is in the head down position, a push rod acting upon the suspension rocker arms is causal to the upper mattress support base rising at the foot end and descending at the head end. In use, this movement is enacted in a continuous, smooth, relaxing and oscillating fashion that renders the precise desired movement to the sleeping surface as this continuous, head and foot movement is transferred to a body laying or sitting on the mattress surface.

In yet another embodiment, a pivoting bracket may be used to convert the longitudinal action of the push-pull rods into a complementary head to toe vertical action to create the ‘arc inertia’ movement. At least two pivoting brackets may be disposed at or near the head and foot portions of the powered bed device, one bracket for each push-pull rod. Also a pivoting bracket may be disposed at or near each corner of the powered bed device in alternate embodiments of the disclosure. A push of a push-pull rod may create a downward motion on the mattress support structure via the pivoting bracket and a pull of the push-pull rod may create an upward motion on the mattress via the pivoting bracket. The bracket may therefore resemble an ‘L’ or a ‘V’ with one leg of the bracket attached to a push-pull rod and the other leg of the bracket attached to the support structure. The intersection of the two legs pivots about a stationary point in the bed structure. The pivot brackets may be fully enclosed within the powered bed device. The push-pull rods may be eccentrically powered by a flywheel or any other type of chain or gear transmission attached to an engine or motor.

An additional benefit that one may perceive while using the present disclosure is a type of full body, internal massage. The gravitational forces acting upon the body actually move the body weight and the internal organs shift ever so slightly such that it provides a gentle sensation to those organs. This motion also “increases circulation of blood and oxygen throughout the body while the user is sleeping. This adds to an overall sense of well-being and relaxation that is extremely conducive to a sound night's sleep and to overall health as well. Also, the disclosed powered bed device therapeutically treats sleepers with acid reflux because the rocking of the device does not go below a horizontal line from a sleeper's head to feet. In other words, the head end of the disclosed bed rises slightly as the foot end dips. The rocking mechanism disclosed may return to a level horizontal position as the rocker reverses to an opposite rocking position without dipping the head end of the bed.

An embodiment of the present disclosure may be designed to allow the user to simply replace their existing box spring with the subject Rocking Box Spring for any bed size including a single, twin, queen, king, crib sized bed and smaller sized beds suitable for animals and the like. This may allow the user of the rocking box spring to receive the benefits of the disclosure without the need to change the geometry of their existing bed system. A rocking adjustable bed or flatbed system could be either placed on top of the rocking box spring device or fully integrated into it as a rocking adjustable bed system device. The disclosed powered rocking bed device will work with adjustable beds and bed systems of various and sundry sorts, air beds, foam mattresses, firm mattresses, soft mattresses, Sealy Posturpedic, Sleep Number, Serta, Simmons, Pillow top, Denver Mattress Company, Leggett and Platt, as well as every known brand of mattress.

A vertical moving pivot with respect to the surface of the bed is disclosed for providing the ocean-like movements. The vertical moving pivot enables arc inertial movements necessary for the ocean-like movements. The vertical moving pivot may move up and down in a track, a slot and other mechanisms to facilitate the ocean-like vertical motion.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A powered rocking bed, comprising: (motion in a straight line)
a) one or more actuators in contact with a rocking frame configured to receive the rocking bed, the actuators configured to act alone or together to rock the bed in one or more dimensions simultaneously; and
b) a processor configured to drive the actuators in one or more predetermined multi-directional and simultaneous ocean-like periodic motions chosen by a user over a period of time also chosen by the user.

2. The powered rocking bed of claim 1, further comprising a plurality of sensors disposed in contact with a user of the bed, the sensors configured to telemetry data from a sleep state physiology of the user to the digital processor to induce rest and sleep.

3. The powered rocking bed of claim 1, further comprising a kill switch activated via any unexpected incident and sensor reading that may indicate an unsafe condition, the kill switch designed to return the rocking bed to a pre-determined position for convenience and safety.

4. The powered rocking bed of claim 1, wherein the predetermined periodic motions include a gentle and stuttered head to foot, side to side, yawing and up to down vertical and horizontal motions acting singularly upon the rocking bed or in simultaneous combined motions.

5. The powered rocking bed of claim 1, wherein the rocking frame comprises a bed, an adjustable bed, a crib, an item of furniture and a vehicle seat.

6. The powered rocking bed of claim 1, further comprising a linkage configured to connect the rocking frame to a base wherein the linkage comprises a U-shaped pivot coupling bracket including an inside bracket and a center pivot bolt.

7. The powered rocking bed of claim 1, further comprising a linkage configured to connect the rocking frame to a base wherein the linkage comprises single and multiple vertical moving pivot points located below the powered rocking bed and laterally positioned in an approximate center thereof.

8. The powered rocking bed of claim 1, wherein the actuators comprise electronic linear actuators.

9. The powered rocking bed of claim 1, further comprising a dc gear motor and a drive train.

10. The powered rocking bed of claim 1, wherein the multi-directional and simultaneous motions that mimic ocean-like motion simulate a floating device at sea such as a catamaran, cruise ship and other buoyant objects.

11. The powered rocking bed of claim 1, wherein the actuators comprise a D.C motor, an A.C. motor, a piston, a linear actuator, a hydraulic piston, a piezoelectric device and an electromagnetic device.

12. A powered rocking bed system, comprising:
a) a plurality of vertical and horizontal actuators in contact with a rocking frame configured to receive the rocking bed, the actuators configured to act alone and to act together to rock the bed in at least one dimension;
b) a discrete digital processor configured to electrically drive the actuators in a plurality of predetermined multi-directional and simultaneous ocean-like periodic motions chosen by a user over a period of time chosen by the user; and
c) a linkage configured to connect the rocking frame to a base and mechanically enable the multi-directional and simultaneous ocean-like periodic motions chosen by the user.

13. The powered rocking bed of claim 12, wherein the discrete digital processor is located in one of a cellular phone, a tablet, a laptop, a desktop, a server, a watch, a digital cloud, and any other personal digital device.

14. The powered rocking bed of claim 12, further comprising a database designed to store a user periodic motion and an adjustable rocking bed position over time periods offered as menu options to the user.

15. The powered rocking bed of claim 12, further comprising a plurality of sensors disposed subcutaneously in a user of the bed, the sensors configured to telemetry data from a sleep state physiology of the user to the digital processor to induce rest and sleep.

16. The powered rocking bed of claim 12, wherein the actuators comprise a direct current motor, an alternating current motor, a piston, a linear actuator, a hydraulic piston, a piezoelectric device, a pneumatic motor, a windup motor and an electromagnetic device.

17. The powered rocking bed of claim 12, wherein the linkage comprises a U-shaped pivot coupling bracket including an inside bracket and a center pivot bolt.

18. The powered rocking bed of claim 12, wherein the linkage comprises single and multiple vertical moving pivot points located below the powered rocking bed and laterally positioned in an approximate center thereof.

19. A powered rocking bed method, comprising:
a) providing at least one actuator in contact with a rocking frame configured to receive the rocking bed, the at least one actuator configured to rock the bed in at least one dimension; and
b) providing a discrete digital processor configured to electrically drive the actuator in a plurality of predetermined multi-directional and simultaneous ocean-like periodic motions chosen by a user over a period of time also chosen by the user.

20. The powered rocking bed method of claim 19, further comprising correlating the motion types chosen by the user to a plurality of sleep states for a plurality of desired sleep state inducements and a continuity of sleep.
